(19) United States
(12) Patent Application Publication
(10) Pub. No.: US 2021/0008800 A1
(43) Pub. Date: Jan. 14, 2021

(54) POWDER MASS ESTIMATES DURING POWDER RECOVERY

(71) Applicant: Hewlett-Packard Development Company, L.P., Spring, TX (US)

(72) Inventors: Eric Scott COLLINS, Vancouver, WA (US); Michael EWE, Vancouver, WA (US); Philip J. STALLBAUMER, Vancouver, WA (US)

(21) Appl. No.: 16/507,640

(22) Filed: Jul. 10, 2019

(51) Int. Cl. B29C 64/357; B33Y 40/00; B33Y 50/00; B29C 64/386; B01D 46/46; B01D 46/00

(52) U.S. Cl. CPC B29C 64/357; B33Y 40/00; B01D 46/0075; B29C 64/386; B01D 46/46; B33Y 50/00

(57) ABSTRACT

An example of an apparatus is provided. The apparatus includes a vacuum source to draw gas and a build material from a build process. The apparatus includes a filter to separate the build material from the gas. A filtered portion of the build material is to be deposited on the filter and a collected portion of the build material is to be redirected. The apparatus includes a storage container to receive the collected portion of the build material. The apparatus includes a mass estimation engine to determine a total mass of the build material. The mass estimation engine is to estimate a mass of the filtered portion.

### BACKGROUND

Printing devices are often used to present information. In particular, printing devices may be used to generate output, such as documents in the case of standard printing devices, or three-dimensional objects in the case of a three-dimensional printing device, that may be easily handled and viewed or read by users. Accordingly, the generation of output from printing devices from electronic form continue to be used for the presentation and handling of information. Some printing devices recycle build materials that may not be used during portions of the build process. Accordingly, build materials are to be collected and transported throughout the printing device. To transport build materials throughout the printing device, build material transport paths may be used where build materials may be carried through conduits using a gas flow.

### BRIEF DESCRIPTION OF THE DRAWINGS

Reference will now be made, by way of example only, to the accompanying drawings in which:

FIG. 1 is a schematic representation of an example apparatus to provide an estimate of the amount of build material in a storage container and filter;

FIG. 2 is a schematic representation of another example apparatus to provide an estimate of the amount of build material in a storage container and filter;

FIG. 3 is a schematic representation of an example controller to control various components and to carry out calculations for an estimate of the build material in a filter; and

FIG. 4 is a flowchart of an example of a method of providing an estimate of the amount of build material in a storage container and filter.

### DETAILED DESCRIPTION

Three-dimensional (3D) printing may produce a 3D object by adding successive layers of build material, such as powder, to a build platform, then selectively solidifying portions of each layer under computer control to produce the 3D object. The build material may be powder, or powder-like material, including metal, plastic, ceramic, composite material, and other powders. In some examples the build material may be formed from, or may include, short fibers that may, for example, have been cut into short lengths from long strands or threads of material. The objects formed may be various shapes and geometries, and may be produced using a model, such as a 3D model or other electronic data source. The fabrication may involve laser melting, laser sintering, heat sintering, electron beam melting, thermal fusion, and so on. The model and automated control may facilitate the layered manufacturing and additive fabrication. The 3D printed objects may be prototypes, intermediate parts and assemblies, as well as end-use products. Product applications may include aerospace parts, machine parts, medical devices, automobile parts, fashion products, and other applications. Some printing devices use powders to generate output. In such printing devices, pneumatic build material delivery systems may be used to deliver a powder from one part of the printing device, such as a hopper to a print head where output is generated. Large printing devices may have large and complex delivery systems for various build materials.

The build material may be a dry, or substantially dry, powder. In a three-dimensional printing example, the build material may have an average volume-based cross-sectional particle diameter size of between about 5 and about 400 microns, between about 10 and about 200 microns, between about 15 and about 120 microns or between about 20 and about 70 microns. Other examples of suitable, average volume-based particle diameter ranges include about 5 to about 70 microns, or about 5 to about 35 microns. As used herein, a volume-based particle size is the size of a sphere that has the same volume as the powder particle. The average particle size is intended to indicate that most of the volume-based particle sizes in the container are of the mentioned size or size range. However, the build material may include particles of diameters outside of the mentioned range. For example, the particle sizes may be chosen to facilitate distributing build material layers having thicknesses of between about 10 and about 500 microns, or between about 10 and about 200 microns, or between about 15 and about 150 microns. One example of a manufacturing system may be pre-set to distribute powdered material layers of about 80 microns using build material containers that include build material having average volume-based particle diameters of between about 40 and about 60 microns. An additive manufacturing apparatus may also be configured or controlled to form powder layers having different layer thicknesses.

As described herein, the build material may be, for example, a semi-crystalline thermoplastic material, a metal material, a plastic material, a composite material, a ceramic material, a glass material, a resin material, or a polymer material, among other types of build material. Further, the build material may include multi-layer structures wherein each particle comprises multiple layers. In some examples, a center of a build material particle may be a glass bead, having an outer layer comprising a plastic binder to agglomerate with other particles for forming the structure. Other materials, such as fibers, may be included to provide different properties, for example, strength.

During the build process, build material, such as powder, is fed into a build chamber. As layers are formed on the object, not all of the build material may be used. For example, excess build material may be lost from a build platform during a printing process such that the build material may be recovered. The excess build material reclaimed may spill-over from the build platform and in the build chamber. The manner by which the excess build material is collected is not particularly limited and may be collected from the build chamber by vacuum, gravity, mechanical conveying, or other methods.

In an example, the excess build material may be collected and placed in a media recovery system hopper. Build material for a build process may be sourced from multiple hoppers in a printing device. For example, a build process may use a ratio of new build material, recycled build material, and excess build material recovered from a media recover system. In order to maintain consistency and quality, the ratio of the three different types of build material is to be maintained substantially steady and that any adjustments to the ratios is to happen gradually.

One reason that gradual adjustments to the ratios are made is to avoid larger more abrupt changes to the ratios. For example, if the media recovery system hopper receives excess build material from the build chamber at a slower rate than the media recovery system hopper reintroduces the build material into the build chamber, the media recovery system hopper will eventually become depleted leading to a drop in recovered build material forming part of the mixture of build material introduced. If this were to happen in the middle of a build process, such a change in composition may occur which may result in a portion of an object having undesired properties, such as low strength. Alternatively, if the media recovery system hopper receives excess build material from the build chamber at a faster rate than the media recovery system hopper reintroduces the build material into the build chamber, the media recovery system hopper will eventually overfill resulting in loss of build material as well as potentially other issues in the printing device, for example, which may stop the build process.

The level of build material in the media recovery system hopper may be controlled to use a slow responding integral controller connected to a device to determine the level build material in the media recovery system hopper. For example, the integral controller may be connected to a load cell to measure weight. Accordingly, the level of powder in the media recovery system hopper may be better controlled such that a somewhat consistent level of reclaimed build material is maintained. An integral controller is to be used to achieve smoother transitions over more abrupt changes.

The manner by which the excess build material is collected from the build chamber is not particularly limited. For example, one method involves using a filter in a stream of gas. In some systems an automated cleaning filter may be used such that build media trapped in the filter is periodically released into the media recovery system hopper, such as through mechanical agitation. However, by periodically cleaning the filter, an abrupt addition of build material into the media recovery system hopper may result in the integral controller slowly adjusting the ratio of build material. This process may lead to slow oscillations that ultimately affect the quality of the build. A method and apparatus may be used to reduce the oscillations created by the filter cleaning operation.

As used herein, any usage of terms that suggest an absolute orientation (e.g. “top”, “bottom”, “vertical”, “horizontal”, etc.) are for illustrative convenience and refer to the orientation shown in a particular figure. However, such terms are not to be construed in a limiting sense as it is contemplated that various components will, in practice, be utilized in orientations that are the same as, or different than those described or shown

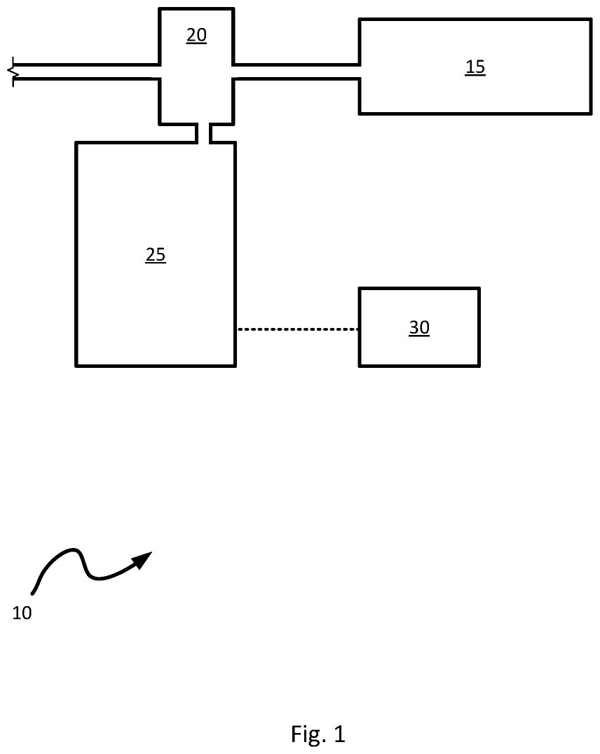

Referring to FIG. 1, an apparatus to provide an estimate of the amount of build material in a storage container and filter is shown at 10. The apparatus 10 may be a part of the printing device or a separate component to operate on the printing device to estimate the amount of reclaimed build material in a printing device during a build process. The apparatus 10 may also include additional components, such as various additional interfaces and/or displays to interact with a user or administrator of the apparatus, such as to monitor and control various components of the printing device. In the specific example, the apparatus 10 is to account for more reclaimed build material by including an estimate of build material that may be trapped in additional components of the recovery system. In the present example, the apparatus 10 includes a vacuum source 15, a filter 20, a storage container 25, and a mass estimation engine 30.

The vacuum source 15 is to draw gas and build material from the build process in the build chamber. In the present example, the vacuum source 15 may be a pump where the pump draws gas from the build chamber and ejects the gas to the ambient air outside of the print device. In other examples, such as a closed system where the gas is recycled, the vacuum source 15 may be to circulate air through the closed system to transport build material to other components of the printing systems. Accordingly, the vacuum source 15 is not particularly limited and may be any device capable of moving air through build material transport path. For example, the vacuum source 15 may be a fan or other turbine that rotates. It is to be appreciated that in some examples, an external vacuum source may be used. Alternatively, the vacuum source 15 of the present example may also be substituted with a pressure source capable of moving build material through a transport system.

The filter 20 is to separate build material from gas. In the present example, the filter may be placed in a build material transport line exiting the build chamber. As reclaimed build material leaves the build chamber, a portion of the build material may be redirected toward the storage container 25 while the gas from the build chamber is allowed to pass through the filter toward the vacuum source 15. The manner by which the build material is redirected by the filter 20 is not particularly limited. In the present example, the filter 20 may be a porous material having a pore size smaller than the size of build material particles. Upon the build material reaching the filter 20, the gas from the build chamber is allowed to pass therethrough while the build material is prevented from moving further along the gas transport system. In some examples, the storage container 25 is to be placed below the filter 20, such that any build material stopped by the filter 20 will fall into the storage container 25 due to gravity to be collected for subsequent re-introduction into the build chamber. In other examples, the filter 20 may also be angled and be made of an elastic material such that the build material will bounce off the filter 20 in a manner that allows the build material to be directed.

It is to be appreciated that during the process of redirecting build material to the storage container 25, a portion of the build material from the build chamber may be deposited onto a membrane (not shown) of the filter 20 and remain temporarily trapped therein. For example, the moving gas through the filter may provide sufficient force to hold the particles of build material against filter 20. In other examples, the build material may become embedded or otherwise stuck in the pores of the filter 20. As yet another example, a portion of the build material from the build chamber may also be trapped within the filter 20, such as on a membrane or other components due to electrostatic forces.

It is to be appreciated that as the build process continues, reclaimed build material may continue to arrive at the filter 20 to be redirected to the storage container 25. At the same time, build material may continue to accumulate on the filter 20. As more build material accumulates on the filter 20, the flow of gas through the filter 20 may become restricted. Accordingly, the efficiency of the vacuum source 15 may be reduced by the blockage of the filter 20. Therefore, the filter 20 may be cleaned periodically to restore functionality. The manner by which the filter 20 is cleaned is not particularly limited. In the present example, the material deposited on the filter 20 is to be removed from the filter 20 and added to the storage container. Since each cleaning of the filter 20 occurs periodically at discrete points in time, the cleaning process leads to a sudden spike in the amount of build material in the storage container 25. The sudden spikes may cause sudden adjustments to the ratio of build material to be introduced into the build chamber as described above if only the weight of build material in the storage container 25 is to be measured.

In the present example, the storage container 25 is to receive the redirected build material, such as powder, from the filter 20. In addition, the storage container 25 is to store the reclaimed build material for continued use in the build process. The storage container 25 is not particularly limited and may include any device capable of storing the build material. In the present example, the storage container 25 is a hopper having a port to receive the reclaimed build material. The storage container 25 may also include various additional ports such as a port for receiving gas or for venting gas and be part of the gas transport system. In addition, the storage container 25 may include an outlet port for removing the build material and transporting the build material back toward the build chamber via the build material transport system (not shown).

Although the present example involves a media recovery system where the build material is reclaimed build material collected from an active build process, other examples are contemplated. Accordingly, the type of build material received in the storage container 25 is also not particularly limited. For example, the storage container 25 may receive a new supply of build material in the form of a powder via the filter 20. In this example, the powder is to be from an external source, instead of a build chamber. The powder from the external source may be drawn into the build material transport system via the vacuum source 15. Accordingly, the filter 20 is to redirect the new build material into the storage container 25 in this example. In another example, the storage container 25 may receive recycled powder prior to the commencement of a build process. Similar to the example of new powder, the recycled powder may be received from an external source that collected unused build material from other build processes.

The mass estimation engine 30 is to determine a mass of the build material trapped in the filter 20 based on a rate of accumulation. The mass of the build material trapped in the filter 20 may subsequently be used to calculate a total mass of build material reclaimed from the build chamber. The total mass of build material includes all build material removed from the build chamber by the vacuum source 15. In the present example, the total mass of build material reclaimed from the build chamber includes the build material redirected into the storage container 25 and the build material trapped in the filter 20. The mass of the build material in the storage container 25 may be directly measured. For example, the mass of the build material in the storage container 25 may be weighed with a load cell. In another example, the height of the build material may be optically measured or inferred from pressure readings and a known density may be used to estimate the mass of the build material in the storage container 25. In yet another example, the mass of the build material in the storage container 25 may be estimated using pressure readings taken at different heights when the build material in the storage container 25 is fluidized.

It is to be appreciated that each of these processes to measure the mass of the build material in the storage container 25 does not take into account the mass of the build material trapped in the filter 20. Upon the cleaning of the filter 20 periodically, an amount of build material will be added to the build material in the storage container 25. Accordingly, the above measurement techniques will show a spike in the amount of build material in the storage container 25. In a media recovery system where an objective is to maintain the amount of build material in the storage container 25, the spikes in the measured mass of the build material in the storage container 25 may result in fluctuations in the flow rate of the build material in the storage container 25 back into the build chamber, which may result in a shock to the overall ratio of build materials after the build material in the storage container 25 mixes with build material from other sources, such as a new build material hopper or a recycled build material hopper.

To reduce the fluctuations in the ratio of build materials, the mass estimation engine 30 is also to estimate the mass of build material trapped in the filter 20. By estimating the mass of build material trapped in the filter 20, the estimated mass of build material trapped in the filter 20 may be added to the measured amount of build material in the storage container 25 to determine a total mass of reclaimed build material from the build chamber. Accordingly, after each periodic removal of the build material trapped in the filter 20, the estimated mass of build material trapped in the filter 20 is to be reset to zero and the additional mass of build material in the storage container 25 may be increased by a corresponding amount. Therefore, the mass fluctuations associated with each clean of the filter 20 is reduced.

The manner by which the mass estimation engine 30 estimates the mass of the build material trapped in the filter 20 is not limited. In the present example, the mass estimation engine 30 may use historical data to determine a rate at which building material accumulates in the filter 20 under specific conditions. For example, the weight of the build material in the storage container 25 may be directly measured before and after each cleaning of the filter 20. Therefore, the weight difference may be assumed to be the amount of build material trapped in the filter 20. This assumed amount of build material trapped in the filter 20 may be used to determine a rate of accumulation on the filter 20. Accordingly, once the rate of accumulation is established based on the historical performance, the mass of build material trapped in the filter 20 may be estimated using this rate of accumulation as well as the known period of time since the last clean of the filter 20.

It is to be appreciated that other manners of estimating the mass of build material trapped in the filter 20 may be used. For example, various sensors may be used on the filter 20 to detect the amount of build material trapped in the filter 20. In particular, additional load cells may be placed in the filter as well as optical sensors.

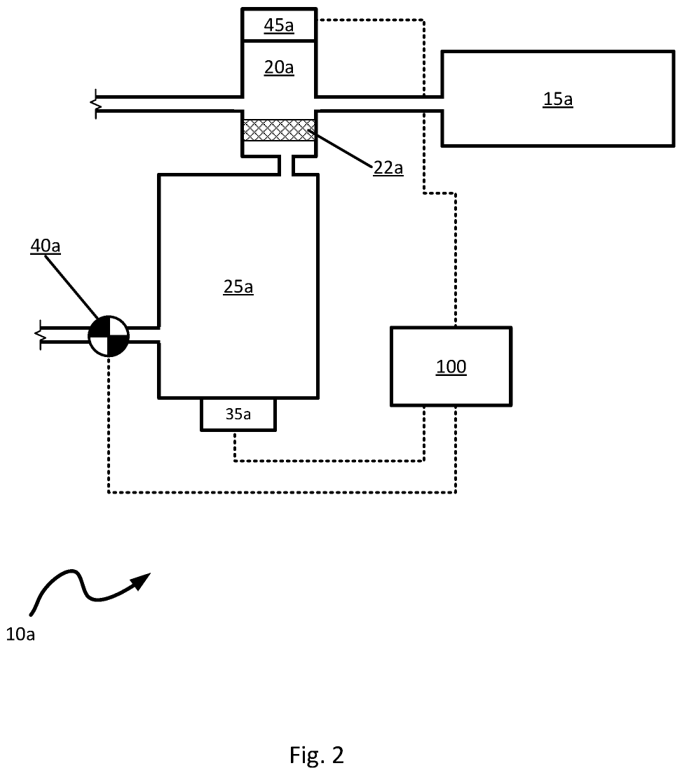

Referring to FIG. 2, another example of an apparatus to provide an estimate of the amount of build material in a storage container and filter shown at 10a. Like components of the apparatus 10a bear like reference to their counterparts in the apparatus 10, except followed by the suffix “a”. The apparatus 10a may be a part of the printing device or a separate component to operate on the printing device to estimate the amount of reclaimed build material in a printing device during a build process. The apparatus 10a includes a vacuum source 15a, a filter 20a, a sieve 22a, a storage container 25a, a load cell 35a, a valve 40a, a powder recovery mechanism 45a, and a controller 100.

In the present example, the filter 20a includes a sieve 22a to remove large particles of build material and/or conglomerated powder received from the build chamber and deflected off the filter 20a. It is to be appreciated that as the build process continues, reclaimed build material may continue to arrive at the filter 20a to be redirected to the storage container 25a. At the same time, build material may accumulate in the filter 20a and in particular on the sieve 22a. As more build material accumulates on the filter 20a, the flow of gas through the filter 20a may become restricted. In addition, as material accumulates on the sieve 22a, the ability of the redirected build material to enter the storage container 25a may also become restricted. Accordingly, the filter 20a and the sieve 22a may be cleaned periodically to restore functionality. The manner by which the filter 20a is cleaned is not particularly limited.

In the present example, the material deposited in the filter 20a is to be removed from the filter 20a and added to the storage container. Similarly, any build material accumulating on the sieve 22a is to be dislodged and allowed to fall into the storage container 25a. In the present example, the powder recovery mechanism 45a is used to release the portion of the build material trapped in the filter 20a. In addition, the powder recovery mechanism 45a may also be used to recovery build material stopped from entering the storage container 25a by the sieve 22a. The build material stopped by the sieve 22a is typically particles adhering to surfaces of the sieve due to some attractive force, such as an electrostatic force or a vacuum force, conglomerated powder particles, or particles of build material that are too large to fit through the sieve 22a. In regard to particles adhering to the sieve 22a and conglomerated particles, a mechanical shaking of the filter 20a and the sieve 22a may be sufficient to overcome any forces to dislodge the particles of build material and/or break up conglomerated particles. For particles of build material too large to fit through the sieve 22a, mechanical vibrations may also be used to break a large particle into multiple smaller particles able to fit through the sieve 22a. Alternatively, the larger particles that are not able to pass the sieve 22a may be removed and discarded.

The powder recovery mechanism 45a is not limited and may be any device capable of recovering build material from the filter 20a and sieve 22a. In the present example, the powder recovery mechanism 45a may be an actuator connected to the filter 20a. The filter 20a may then be moveably connected to the powder transport system such that the powder recovery mechanism 45a may shake the filter 20a. In the present example, as the filter 20a shakes, the sieve 22a will also shake. The speed, duration, and intensity of the shaking is not limited and may be varied depending on tendency of the build material to become trapped in the filter 20a and/or sieve 22a.

In the present example, the filter 20a and the sieve 22a are cleaned periodically. For example, the powder recovery mechanism 45a may be off during a majority of the time during a build process and activated when the filter 20a and the sieve 22a are to be cleaned. In the present example, the controller 100 may be used to control the operation of the powder recovery mechanism 45a. The manner and frequency by which controller 100 operates the powder recovery mechanism 45a is not limited. For example, the controller 100 may operate the powder recovery mechanism 45a in a time-based manner, such as after a predetermined period of time, for example, about every five minutes during a build process. In another example, the controller 100 may operate the powder recovery mechanism 45a in an event-based manner, such as after the completion of a layer in the build process or based on a sensor reading such as a pressure drop across the filter 20a. In further examples, a combination of triggers may be used such as an event-based trigger with a time-based trigger if the event does not occur within a certain period of time.

The load cell 35a is mounted to the bottom of the storage container 25a. The load cell 35a is not particularly limited and may be any device capable of measuring a weight. In the present example, the load cell 35a is a digital spring scale. Accordingly, the load cell 35a is to measure the weight of both the storage container 25a and the build material therein. Since the weight of the storage container 25a is known, the weight of the build material therein may be calculated. During operation, the cleaning process carried out by the powder recovery mechanism 45a leads to a sudden spike in the amount of build material in the storage container 25a and thus to a sudden increase in the weight measured by the load cell 35a. The difference in weight before and after the cleaning operation represents the weight of the build material recovered from the filter 20a and the sieve 22a. In the present example, the weight of the build material recovered from the filter 20a and the sieve 22a and the weight of the build material in the storage container 25a is substantially the weight of the build material reclaimed from the build chamber. However, in other examples, where some build material stopped by the sieve 22a is discarded due to a large particle size that may not be suitable for reuse in the build process, the weight of the build material recovered from the filter 20a and the sieve 22a and the weight of the build material in the storage container 25a may be less.

The valve 40a is to control the flow rate of the build material in the storage container 25a. In the present example, the valve 40a is an electronically controlled valve operated by the controller 100. The controller 100 is to adjust the valve 40a slowly in response to the amount and rate of building material received by the storage container. In particular, the controller 100 may allow a faster rate of build material flowing out of the storage container 25a by opening the valve 40a further. Alternatively, the controller 100 may slow the rate of build material flowing out of the storage container 25a by partially closing the valve 40a. Therefore, the controller 100 may adjust the flow rate to maintain a substantially steady amount of build material in the storage container 25a.

In the present example, the controller 100 is in communication with the load cell 35a, the valve 40a, and the powder recover system 45a. The controller 100 is to send and receive signals from various components of the apparatus 10a. For example, the controller may receive raw data from the load cell 35a to estimate the mass of build material trapped in the filter 20a. In addition, the controller 100 may be used to control the valve 40a to adjust the flow of reclaimed build material back into the build process.

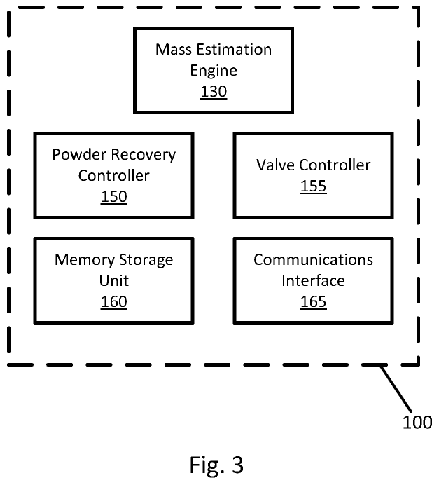

Referring to FIG. 3, the components of the controller 100 are shown in greater detail. It is to be appreciated that the controller 100 is not limited and may be part of the larger printing device. For example, the controller 100 may be a dedicated portion of the main processor of the printing device. In other examples, the controller 100 may be a stand-alone unit added to the printing device. The controller includes a mass estimation engine 130, a powder recovery controller 150, a valve controller 155, a memory storage unit 160, and a communication interface 165.

In the present example, the mass estimation engine 130 is to determine a total mass of build material reclaimed from the build chamber. The total mass of build material includes the build material redirected into the storage container 25a and the build material trapped in the filter 20a or the sieve 22a. The mass of the build material in the storage container 25a may be directly measured by the load cell 35a. The mass of build material trapped in the filter 20a and the sieve 22a may be estimated using historical data.

In the present example, the mass estimation engine 130 estimates the mass of the build material trapped in the filter 20a and the sieve 22a by determining a rate at which building material accumulates in the filter 20a and the sieve 22a under operating conditions. In particular, the load cell 35a may be used to measure the weight of the build material in the storage container 25a before and after each cleaning of the filter 20a and the sieve 22a by the powder recovery mechanism 45a. Therefore, the weight difference represents the actual mass of build material trapped in the filter 20a and the sieve 22a after carrying out a build material recovery operation by the powder recovery mechanism 45a. The mass estimation engine 130 may then calculate an average rate of accumulation in the filter 20a and the sieve 22a based on a known elapsed time from the previous build material recovery operation. The rate may then be used to calculate an estimated mass of build material trapped in the filter 20a and the sieve 22a based on the elapse time since the last build material recovery operation assuming the average accumulation rate is unchanged in the subsequent iteration of the build material recovery process. It is to be appreciated that even in examples where an amount of build material is discarded by the sieve 22a, the average accumulation rate may still be used to estimate the amount of build material in the filter 20a and the sieve 22a since the amount discarded may be assumed to be the same after each operation of the powder recovery mechanism 45a.

The powder recovery controller 150 is to control the powder recovery mechanism 45a. In the present example, the powder recovery controller 150 is to execute a cleaning process of the filter 20a and the sieve 22a periodically. For example, the powder recovery controller 150 may activate the powder recovery mechanism 45a in a time-based manner, such as after a predetermined period of time, for example, about every five minutes during a build process. In another example, the powder recovery controller 150 may activate the powder recovery mechanism 45a in an event-based manner, such as after the completion of a layer in the build process or if the filter 20a and/or sieve 22a become full. The manner by which the filter 20a and/or sieve 22a is determined to be full is not particularly limited and may involve measuring pressure differentials on either side of the filter 20a, obtaining a mass flow reading, or measuring the weight change of the filter 20a with a load cell.

The valve controller 155 is to operate the valve 40a to adjust the flow rate of the build material from the storage container 25a back into the build chamber. Accordingly, the valve controller 155 is to use the rate at which build material leaves the storage container 25a to maintain a target amount of mass in the storage container as reclaimed build material is added to the storage container 25a from the filter 20a.

The memory storage unit 160 is to store data and may include a non-transitory machine-readable storage medium that may be any electronic, magnetic, optical, or other physical storage device. The non-transitory machine-readable storage medium may include, for example, random access memory (RAM), electrically-erasable programmable read-only memory (EEPROM), flash memory, a storage drive, an optical disc, and the like. The memory storage unit 160 may also be encoded with executable instructions to operate the apparatus 10a. In other examples, it is to be appreciated that the memory storage unit 160 may be substituted with a cloud-based storage system.

The memory storage unit 160 may also store an operating system that is executable by the controller 100 to provide general functionality to the apparatus 10a, for example, functionality to support various applications such as a user interface to access various features of the apparatus 10a. Examples of operating systems include Windows™, macOS™, iOS™, Android™, Linux™′ and Unix™. The memory storage unit 160 may additionally store applications that are executable by the controller 100 to provide specific functionality to the apparatus 10a, such as those described herein.

The communications interface 165 is to communicate with external devices. In particular, the communications interface 165 is to send commands and data to an external device, such as a remote server or client device, and to receive commands and data from the external device. For example, the communications interface 165 may be used to transmit data to a server, such as a print service, to alert an administrator that the powder level is too low or to allow the print service to monitor the build process as well as the build material recovery process.

The manner by which the communication interface 165 sends and receives data is not particularly limited. In the present example, the communication interface 165 may be a wireless interface to communicate with an external device over short range distances using ultra high frequency radio waves. In particular, the communication interface 165 may be to use a standard, such as Bluetooth. In other examples, the communication interface 165 may connect to an external device, such as a print server, via the Internet, or may connect via wireless or wired connections with other components or processor of the printing device.

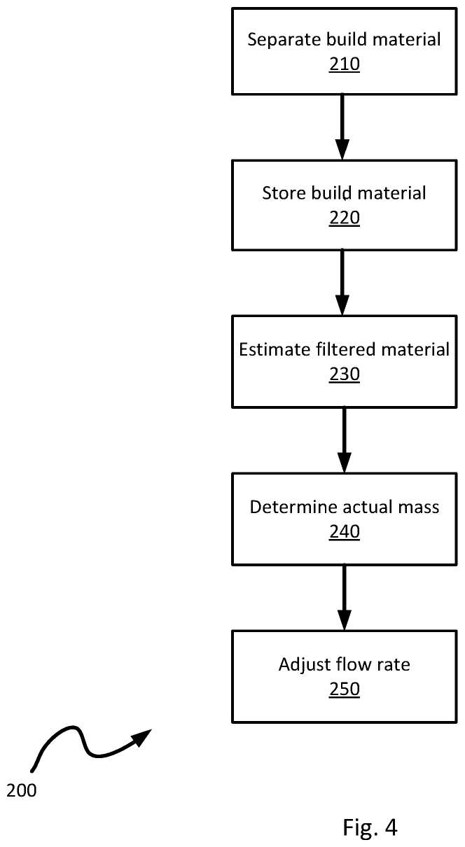

Referring to FIG. 4, a flowchart of a method of estimating the amount of build material in a storage container 25a and filter 20a is shown at 200. In order to assist in the explanation of method 200, it will be assumed that method 200 may be performed with the apparatus 10a. Indeed, the method 200 may be one way in which apparatus 10a may be configured. Furthermore, the following discussion of method 200 may lead to a further understanding of the apparatus 10a and its various components. Furthermore, it is to be emphasized, that method 200 may not be performed in the exact sequence as shown, and various blocks may be performed in parallel rather than in sequence, or in a different sequence altogether.

Block 210 involves separating the build material from a gas in a powder transport system using a filter 20a. In the present example, the filter 20a includes pores to allow the gas to flow therethrough and to prevent the build material from passing. Accordingly, the majority of the build material is redirected to the storage container 25a, where it is stored in the storage container 25a in block 220. It is to be appreciated that while most of the build material is redirected, a smaller portion is trapped on the filter 20a during normal operation.

In blocks 230, the build material trapped in the filter 20a is to be estimated by the mass estimation engine 130. The manner by which the mass of the build material trapped in the filter 20a is estimated is not particularly limited and may involve any one of the methods discussed above. Next the actual mass of the build material in the storage container 25a is determined in block 240. In the present example, the load cell 35a is used to measure the weight of the build material, which is subsequently used to calculate the mass of the build material trapped in the filter 20a.

Block 250 comprises adjusting the rate at which build material flows from the storage container 25a back into the build chamber. In the present example, the combined mass of the amount of build material in the storage container 25a measured with the load cell and the estimated amount trapped in the filter 20a and the sieve 22a is to be used. Accordingly, when the build material trapped in the filter 20a and the sieve 22a is to be recovered, such as by shaking, the mass used to determine how the valve 40a is to be adjusted is not faced with as large of a spike from the addition of build material from the filter 20a and the sieve 22a into the storage container 25a.

It should be recognized that features and aspects of the various examples provided above may be combined into further examples that also fall within the scope of the present disclosure.

What is claimed is:

1. An apparatus comprising:
a vacuum source to draw gas and a build material from a build chamber;
a storage container to receive a collected portion of the build material;
a filter to allow the gas to pass therethrough, to redirect the collected portion of the build material to the storage container, and to collect a filtered portion of the build material on a filter membrane at a rate of accumulation; and
a mass estimation engine to determine a mass of the filtered portion based on the rate of accumulation.

2. The apparatus of claim 1, further comprising a powder recovery mechanism, wherein the powder recovery mechanism is to release the filtered portion into the storage container.

3. The apparatus of claim 2, wherein the powder recovery mechanism operates periodically.

4. The apparatus of claim 3, wherein the powder recovery mechanism operates based on a pressure drop across the filter.

5. The apparatus of claim 2, wherein the powder recovery mechanism is an actuator to shake the filter.

6. The apparatus of claim 2, further comprising a load cell mounted below the storage container, the load cell to measure a weight of the build material in the storage container.

7. The apparatus of claim 6, wherein the mass estimation engine is to calculate an actual mass of the filtered portion from a weight difference with the load cell after an operation of the powder recovery mechanism.

8. The apparatus of claim 7, wherein the mass estimation engine is to use the weight difference to be used to determine the rate of accumulation.

9. A method comprising:
separating a build material from a gas with a filter, wherein the filter traps a filtered portion of the build material at a rate of accumulation, and redirects a collected portion of the build material to a storage container;
storing the collection portion of the build material in the storage container;
estimating a filtered mass of the filtered portion based on the rate of accumulation;
determining a mass of the collected portion; and
adjusting a flow rate of the build material from the storage container based on the determined mass of the collected portion and the filtered portion.

10. The method of claim 9, further comprising recovering the filtered portion of the build material.

11. The method of claim 10, wherein recovering the filtered portion of the build material comprises shaking the filter.

12. The method of claim 9, wherein determining the mass of the collected portion comprises measuring a weight of the build material with a load cell.

13. A non-transitory machine-readable storage medium encoded with instructions executable by a processor of an electronic device to:
determine a mass of a build material in a storage container;
estimate a filtered mass of the build material based on a rate of accumulation, wherein the filtered mass represents an amount of build material collected in a filter; and
adjust a flow rate of the build material from the storage container to a build chamber based on the mass of the build material in the storage container and the filtered mass.

14. The non-transitory machine-readable storage medium of claim 13, wherein the instructions when executed further cause the processor to calculate a weight difference between a first weight before a recovery procedure and a second weight after the recovery procedure to determine the rate of accumulation.

15. The non-transitory machine-readable storage medium of claim 14, wherein the instructions when executed further cause the processor to use the rate of accumulation to estimate a subsequent filtered mass.
